(19) United States
(12) Patent Application Publication
(10) Pub. No.: US 2024/0057813 A1
(43) Pub. Date: Feb. 22, 2024

(54) LID ASSEMBLY AND COOKING APPARATUS

(71) Applicant: FOSHAN SHUNDE MIDEA ELECTRICAL HEATING APPLIANCES MANUFACTURING CO., LTD., FOSHAN (CN)

(72) Inventors: Hanjie HU, FOSHAN (CN); Xiongwei GUO, FOSHAN (CN)

(21) Appl. No.: 18/549,917

(22) PCT Filed: Apr. 29, 2022
(86) PCT No.: PCT/CN2022/090774

§ 371 Date: Sep. 10, 2023

(30) Foreign Application Priority Data
Jun. 30, 2021 (CN) 202121474046.9

(51) Int. Cl. A47J 36/38; A47J 27/00; A47J 36/06; A47J 36/32

(52) U.S. Cl. CPC A47J 36/38; A47J 27/00; A47J 36/06; A47J 36/32

(57) ABSTRACT

Provided are a lid assembly and a cooking apparatus, which relate to the field of cooking appliances. The lid assembly includes: an upper lid having a first mounting region and a second mounting region that are spaced apart by a first preset value in a projection of a first plane perpendicular to a thickness direction of the upper lid, in which the first mounting region has a through hole configured to discharge steam; and a ventilation apparatus configured to generate an airflow and connected to the upper lid, in which the ventilation device is disposed in the second mounting region.

### CROSS-REFERENCES TO RELATED APPLICATIONS

The present disclosure is a national phase application of International Application No. PCT/CN2022/090774, filed on Apr. 29, 2022, which claims priority to Chinese Patent Application No. 202121474046.9 filed on Jun. 30, 2021, the entireties of which are herein incorporated by reference.

### FIELD

The present disclosure relates to the field of cooking appliances, and more particularly, to a lid assembly and a cooking apparatus.

### BACKGROUND

A cooking apparatus is an apparatus that converts electrical energy or other energy sources into thermal energy to heat food. The cooking apparatus includes a body and a lid assembly. The body has a cooking cavity with an opening at an end of the body. The lid assembly is configured to expose or close the opening end of the cooking cavity. Steam generated in the cooking cavity is discharged to an ambient environment through the lid assembly. The related lid assembly is provided with a ventilation device configured for ventilation with the cooking cavity, but the position of the ventilation device is not flexible and is limited.

### SUMMARY

In view of the above, the present disclosure provides a lid assembly and a cooking apparatus to solve the problem how to improve flexibility of positioning a ventilation device.

The embodiments of the present disclosure are provided as follows.

Embodiments of the present disclosure provide a lid assembly. The lid assembly includes an upper lid and a ventilation device. The upper lid has a first mounting region and a second mounting region. In a projection of the upper lid on a first plane, the first mounting region and the second mounting region are spaced apart from each other by a first predetermined value. The first plane is perpendicular to a thickness direction of the upper lid. A through hole is formed in the first mounting region and configured to discharge steam. The ventilation device is configured to generate an airflow and connected to the upper lid. The ventilation device is disposed in the second mounting region.

Further, the first predetermined value is greater than or equal to 20 mm.

Further, the upper lid further has a third mounting region that is spaced apart from each of the first mounting region and the second mounting region. The lid assembly further includes a control panel disposed in the third mounting region.

Further, the second mounting region and the third mounting region are spaced apart from each other by a second predetermined value greater than or equal to 20 mm.

Further, the ventilation device includes an airflow generating device configured to generate the airflow in an operating state, and the control panel is configured to control the airflow generating device to operate.

Further, the ventilation device further includes an externalized assembly in communication with the airflow generating device, and the externalized assembly is configured to display the airflow.

Further, the second mounting region is located between the first mounting region and the third mounting region.

Further, the externalized assembly includes a movable component and a transparent lid. The movable component is configured to move under pushing of the airflow generated by the airflow generating device. The transparent lid is disposed above the movable component and configured to observe the movement of the movable component.

Further, the upper lid has a first accommodation cavity, the movable component is accommodated within the first accommodation cavity, and the transparent lid is fixedly connected to the upper lid to close an opening at an end of the first accommodation cavity; or the externalized assembly further includes a housing having a second accommodation cavity, the movable component is accommodated within the second accommodation cavity, and the transparent lid is connected to the housing to close an opening at an end of the second accommodation cavity. The externalized assembly is fixedly connected to the upper lid.

Embodiments of the present disclosure provide a cooking apparatus. The cooking apparatus includes the lid assembly according to any one of the lid assemblies described above and a body having a cooking cavity with an opening at an end of the body. The lid assembly is configured to expose or close the opening of the cooking cavity, and the ventilation device is configured to generate an airflow to disturb gas in the cooking cavity.

According to the embodiments of the present disclosure, the lid assembly includes the upper lid and the ventilation device. The upper lid has the first mounting region and the second mounting region that are spaced apart from each other by the first predetermined value in the projection of the upper lid on the first plane. The through hole is formed in the first mounting region and configured to discharge steam, and the ventilation device is disposed in the second mounting region. Since the steam discharging region and the ventilation device are disposed in different regions, the ventilation device is located away from the steam discharging region to effectively reduce possibility that the steam enters the ventilation device, to further effectively improve stability of the operating state of the ventilation device and service life of the ventilation device. In addition, the ventilation device can be disposed at any position other than the steam discharging region, which effectively improves the flexibility and selectivity of the position of the ventilation device.

### BRIEF DESCRIPTION OF THE DRAWINGS

FIG. 1 is a bottom view of a lid assembly according to an embodiment of the present disclosure.

FIG. 2 is a sectional view of an internal structure of a cooking apparatus according to an embodiment of the present disclosure.

FIG. 3 is a schematic diagram showing ventilation of a cooking apparatus according to an embodiment of the present disclosure.

FIG. 4 is a sectional view of a lid assembly according to an embodiment of the present disclosure.

FIG. 5 is a sectional view of another lid assembly according to an embodiment of the present disclosure.

### REFERENCE SIGNS

1. cooking apparatus; 10. lid assembly; 11. upper lid; 11A. through hole; 11B. first accommodation cavity; 12. ventilation device; 121. airflow generating device; 122. externalized assembly; 122A. second accommodation cavity; 1221. movable component; 1222. transparent lid; 1223. housing; 123. gas guiding component; 20. body; 20A. cooking cavity; 13. control panel; 14. sealing isolation component; S1. first mounting region; S2. second mounting region; and S3. third mounting region.

### DETAILED DESCRIPTION OF THE DISCLOSURE

In order to make the embodiments of the present disclosure more apparent, some embodiments of the present disclosure will be described in detail below with reference to the accompanying drawings. It should be understood that the some embodiments described herein are only used to explain the present disclosure, rather than to limit the present disclosure thereto.

The specific features described in the embodiments may be combined in any suitable manner without contradiction, for example, different embodiments may be obtained by combining different specific features. To avoid unnecessary repetition, various possible combinations of various specific features in the present disclosure are not described separately.

In the following description, terms “first\second\ . . . ” merely distinguish between different objects, and does not indicate that the objects have anything in common or related to each other. It should be understood that the orientation descriptions “above”, “below”, “outside” and “inner” are all directions in the normal state of use, and the “left” and “right” directions represent the left-right direction illustrated in a specifically corresponding schematic diagram, which may or may not be the left and right directions in the normal state of use.

It should be noted that terms “comprise”, “include” or any other variations thereof are meant to cover non-exclusive inclusion, such that the process, method, goods or device including a series of elements do not only include those elements, but further include other elements that are not explicitly listed, or further include inherent elements of the process, method, goods or device. Without further limitation, an element defined by the statement “includes a . . . ” does not exclude the presence of additional identical elements in the process, method, goods or device that includes that element.

The present disclosure provides a lid assembly and a cooking apparatus. The lid assembly may be used as a pot cover applied in cooking apparatus such as electric rice cookers, steamers, and electric pressure cookers. It should be noted that the type of application scenario of the present disclosure does not limit a structure of the lid assembly of the present disclosure. For ease of description, the lid assembly applied in the electric rice cooker is taken as an example for specific description of the lid assembly.

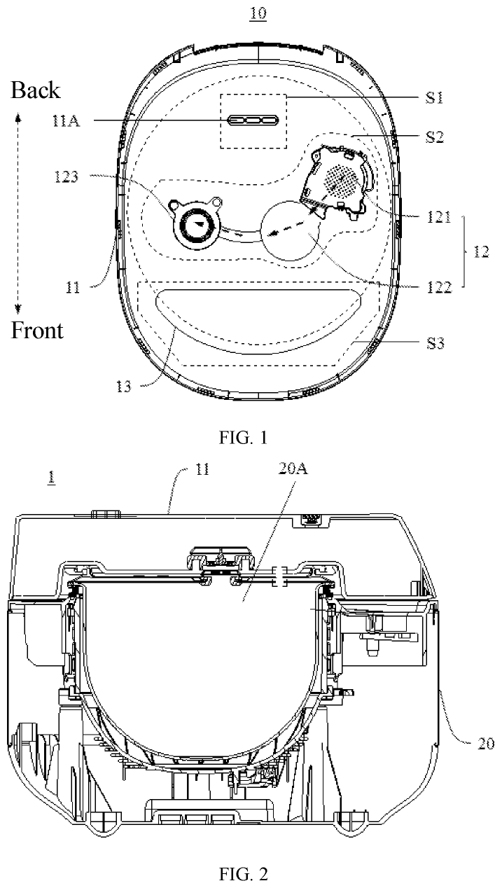

In the embodiments of the present disclosure, as illustrated in FIG. 1 and FIG. 2, a cooking apparatus 1 includes a lid assembly 10 and a body 20 for cooking. The body 20 has a cooking cavity 20A with an opening at an end of the body 20, and the lid assembly 10 may be configured to expose or close the opening of the cooking cavity 20A. The lid assembly 10 includes an upper lid 11 and a ventilation device 12. In some embodiments, as illustrated in FIG. 2, the upper lid 11 may be an integral member configured to cover the body of the cooking apparatus 1 to expose or close the cooking cavity 20A. The upper lid 11 may be a lid body formed by connecting components to expose or close the cooking cavity 20A. For example, the upper lid 11 may include a surface lid and an inner lid that are disposed from outside to inside, a hollow cavity is formed between the surface lid and the inner lid, and the hollow cavity may be used to arrange various components such as a display panel assembly and a ventilation device. The upper lid 11 may be a part of the lid body configured to expose or close the cooking cavity 20A. For example, the upper lid 11 may be the surface lid. The following describes the upper lid 11 as a surface lid of the lid body, and specific constitution and form of the upper lid 11 do not affect the definition of the lid assembly in the present disclosure.

As illustrated in FIG. 1, the upper lid 11 has a first mounting region S1 and a second mounting region S2 that are spaced apart from each other by a first predetermined value in a projection of the upper lid 11 on a first plane, and the first plane is perpendicular to a thickness direction of the upper lid 11. In some embodiments, the upper lid 11 may be a substantially thin wall member with a wall thickness, and the wall thickness is a thickness of the upper lid 11. In a normal state of use, as illustrated in FIG. 2, the thickness direction of the upper lid 11 may be an up and down direction. The first plane is perpendicular to the thickness direction of the upper lid 11, and thus a direction along which the first plane extends is a substantially horizontal plane direction. The upper lid 11 has an area and may form a projection surface on the first plane, and a surface of the upper lid 11 capable of forming the projection surface on the first plane is referred to as a projected surface. The projected surface is divided into functional regions based on areas and/or positions to effectively distinguish different functional regions. For example, the projected surface of the upper lid 11 includes the first mounting region S1 and the second mounting region S2 that are spaced apart from each other. A distance at which the first mounting region S1 and the second mounting region S2 are spaced apart from each other may be flexibly set based on an actual requirement, and a specific distance at which the two regions are spaced apart from each other may be represented by a minimum distance between two points in the two regions. An area of the first mounting region S1 and an area of the second mounting region S2 may be identical or different, and a specific area may be flexibly set based on an actual dimension of the projected surface. A shape of each of the first mounting region S1 and the second mounting region S2 may be flexibly set based on the actual requirement, which is not specifically limited herein.

As illustrated in FIG. 1, a through hole 11A is formed in the first mounting region S1 to discharge steam. In some embodiments, the upper lid 11 located in the first mounting region S1 may be directly recessed toward the cavity to form the through hole 11A in communication with ambient environment, and the through hole 11A may be used as a steam channel to discharge steam generated in the body 20 of the cooking apparatus 1 to the ambient environment. A specific form of discharging steam can be flexibly set. In an embodiment, the through hole 11A extends directly through the inner lid into the cooking cavity 20A. As a result, the steam generated in the cooking cavity 20A is directly discharged to the ambient environment through the through hole 11A. In another embodiment, a connecting tube is disposed at an end of the through hole 11A close to the cooking cavity 20A, and the connecting tube communicates with the cooking cavity 20A. That is, the steam may be in direct contact with the wall surface of the through hole 11A. In some embodiments, the steam may not be in direct contact with the wall surface of the through hole 11A. For example, a steam valve is disposed in the through hole 11A as an independent component, and the steam in the cooking cavity is discharged through the steam valve.

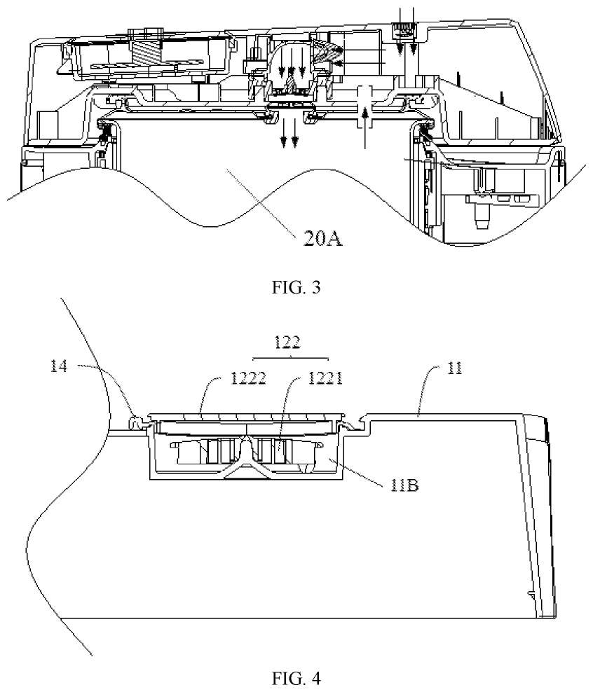

It can be understood that after cereal such as rice is husked, the surface of the cereal is oxidized, and a substance with a stale smell is produced. Taking the rice as an example, the surface of the husked rice is oxidized to form stale rice. The substance with the stale smell may be released in a form of gas during cooking of the stale rice, causing the rice to have the stale smell and poor taste. As illustrated in FIG. 3, the ventilation device is disposed in the cooking apparatus 1, and the ventilation device may be a component having a blowing function toward the cooking cavity 20A. That is, the ventilation device can continuously draw airflow from the ambient environment into the cooking cavity 20A, and at least part of the gas in the cooking cavity 20A can be discharged to the ambient environment through the steam channel under a pressure difference. Arrows in FIG. 3 indicate a flow path of the airflow. In this way, at least part of the gas having the stale smell in the cooking cavity 20A is replaced by new fresh air to realize replacement of the gas in the cooking cavity 20A, i.e., ventilation, to reduce the stale smell of the rice, achieving an effect of removing the stale smell, and improving the taste of the rice. The ventilation device may be a component having a function of suctioning the gas from the cooking cavity 20A, and the gas of the cooking cavity 20A is continuously suctioned to be discharged to the ambient environment. An air inlet port may be provided at the cooking apparatus and is in communication with the ambient environment, to enable the air in the ambient environment to be supplied into the cooking cavity 20A through the air inlet port. In this case, the function of ventilation can be achieved.

As illustrated in FIG. 1, the ventilation device 12 is configured to generate airflow and connected to the upper lid 11. In some embodiments, the ventilation device 12 is located in the hollow cavity of the lid assembly 10 and connected to the upper lid 11. The ventilation device 12 can generate the airflow in an operating state to disturb the gas in the cooking cavity 20A, to achieve ventilation.

As illustrated in FIG. 1, the ventilation device 12 is disposed in the second mounting region S2. In some embodiments, the ventilation device 12 is arranged in the second mounting region S2, and is electrically energized in the operating state. When the steam enters the ventilation device 12, condensed water formed after steam condensation may cause the ventilation device 12 to malfunction, e.g., short circuit. The first mounting region S1 and the second mounting region S2 are spaced apart from each other by the first predetermined value. In this way, the two regions are separated and maintain a distance therebetween. As a result, the steam discharged from the through hole 11A located in the first mounting region S1 is unlikely to enter the ventilation device 12 located in the second mounting region S2, to effectively improve stability of the operating state of the ventilation device 12 and service life of the ventilation device 12. In addition, the ventilation device 12 may be disposed at any position other than the first mounting region S1 on the projected surface of the upper lid 11, which can effectively improve flexibility and selectivity of setting the position of the ventilation device 12.

The lid assembly of the present disclosure includes the upper lid and the ventilation device. The upper lid has the first mounting region and the second mounting region that are spaced apart by the first predetermined value in the projection of the upper lid on the first plane. The through hole is formed in the first mounting region and configured to discharge the steam, and the ventilation device is disposed in the second mounting region. Since the steam discharging region and the ventilation device are disposed in different regions, the ventilation device is located far away from the steam discharging region to effectively reduce possibility that the steam enters the ventilation device, to further effectively improve stability of the operating state of the ventilation device and service life of the ventilation device. In addition, the ventilation device may be disposed at any position other than the steam discharging region, which effectively improves the flexibility and selectivity of setting the position of the ventilation device.

In some embodiments, the first predetermined value is greater than or equal to 20 mm. In some embodiments, the distance at which the first mounting region S1 and the second mounting region S2 are spaced apart from each other should not be too small. A too small distance may cause the steam discharged from the first mounting region S1 to easily flow into the ventilation device 12 located in the second mounting region S2, and the condensed water formed after the steam condensation may cause excessive humidity in the ventilation device 12, which affects the normal operation and service life of the ventilation device 12, and even directly causes the malfunction such as short circuit. In an embodiment, the distance at which the first mounting region S1 and the second mounting region S2 are spaced apart from each other may be greater than or equal to 20 mm. The distance between the two mounting regions is defined to enable the stability of the operating state of the ventilation device and the service life of the ventilation device to be further effectively improved. In some embodiments, a boundary of the first mounting region S1 includes numerous points that may be recorded as a set of points A, and a boundary of the second mounting region S2 also includes numerous points that may be recorded as a set of points B. The distance at which the first mounting region S1 and the second mounting region S2 are spaced apart from each other is considered as a minimum value of connecting line lengths between the points A and the points B. That is, the distance between the boundary of the first mounting region S1 and the boundary of the second mounting region S2 is greater than or equal to the minimum value.

In some embodiments, as illustrated in FIG. 1, the upper lid 11 further has a third mounting region S3 spaced apart from each of the first mounting region S1 and the second mounting region S2. In some embodiments, the projected surface of the upper lid 11 is divided into more regions to fully utilize the regions of the upper lid 11, to effectively improve functional diversity of the lid assembly 10. In an embodiment, the projected surface of the upper lid 11 may be divided into three regions based on the actual requirement that are space apart from each other, and the three regions are the first mounting region S1, the second mounting region S2, and the third mounting region S3, respectively. The third mounting region S3 is configured to arrange the control panel 13, where a user can perform a series of operations such as functional selection, switching, turning on, and turning off. In some embodiments, the control panel 13 may be configured to display related operating parameters of the cooking apparatus. The operating parameters include an operation duration of the cooking apparatus, an operation mode, the operating state and the like. The shapes of the three regions may be identical or different, the areas of the three regions may be identical or different, and relative positions of the three regions are arbitrary. The projected surface of the upper lid is divided into three regions with different functions. As a result, the functions of the three regions are explicitly distinguished.

In some embodiments, the second mounting region S2 and the third mounting region S3 are spaced apart from each other by a second predetermined value. The definition of the distance between the second mounting region S2 and the third mounting region S3 is similar to that of the distance between the first mounting region S1 and the second mounting region S2, that is, a minimum distance between two points on the boundaries of the second mounting region S2 and the third mounting region S3. In some embodiments, during operation of the ventilation device 12 located in the second mounting region S2, a flow region of the airflow is formed in the second mounting region S2. Since the ventilation device 12 is in communication with the cooking cavity 20A, a part of the steam generated in the cooking cavity 20A may enter the airflow channel of the ventilation device 12 during the operation of the cooking apparatus 1, to cause high humidity of the second mounting region S2. The control panel 13 disposed in the third mounting region S3 is an electrical element, and therefore the environment with the high humidity may affect the normal operation of the control panel 13. In view of use safety and stability of the control panel 13, the distance at which the second mounting region S2 and the third mounting region S3 are spaced apart from each other should not be too small. In an embodiment, the distance at which the second mounting region S2 and the third mounting region S3 are spaced apart from each other may be greater than or equal to 20 mm. In some embodiments, the second mounting region S2 is located between the first mounting region S1 and the third mounting region S3. In an embodiment, for a clamshell cooking apparatus 1, the lid assembly 10 is rotatably connected to the body 20 by a hinge assembly, the first mounting region S1 is disposed close to the hinge assembly, and the third mounting region S3 is disposed away from the hinge assembly. In the normal state of operation, the hinge assembly is located at the rear of the cooking apparatus 1 (at a top position as illustrated in FIG. 1), and a user is located in front of the cooking apparatus 1 (at a lower position as illustrated in FIG. 1). That is, the first mounting region S1 may be disposed close to the rear of the upper lid 11, and the third mounting region S3 may be disposed close to the front of the upper lid 11. Therefore, the third mounting region S3 is closest to the operation range of the user, which is convenient for the user to operate. Furthermore, since the first mounting region S1 is farther away from the user. As a result, a risk of scalding the user from the steam exiting the first mounting region S1 can be effectively reduced. The distance by which the two mounting regions are spaced apart from each other is defined to enable stability and safety of the operating state of the control panel and service life of the control board to be improved.

In some embodiments, as illustrated in FIG. 1, the ventilation device 12 includes an airflow generating device 121 configured to generate airflow in the operating state. In some embodiments, the airflow generating device 121 may be a blower with a blowing function, or may be a pump body with a function of pumping gas, both of which may generate airflow in the operating state. In some embodiments, the following will continue to describe the airflow generating device 121 as a device having the blowing function. The airflow generating device 121 may be disposed in the hollow cavity directly in a form of an impeller, and an air inlet port is formed in the upper lid 11. The airflow generating device 121 can generate a negative pressure in the hollow cavity in the operating state, to allow ambient air to be suctioned into the hollow cavity through the air inlet port to form an airflow. The arrows in FIG. 1 indicate the flow path of the airflow. The airflow generating device 121 may be a structure in a form of an impeller and a casing. The casing forms an air duct, and the impeller is disposed in the casing. The airflow generating device 121 can directly suction the ambient air into the air duct to form the airflow in the operating state. The airflow generating device 121 may be directly in communication with the cooking cavity 20A. In an embodiment, as illustrated in FIG. 1, a gas guiding component 123 is provided. An end of the gas guiding component 123 is in communication with the airflow generating device 121, and another end of the gas guiding component 123 is in communication with the cooking cavity 20A. The gas guiding component 123 can guide the airflow generated by the airflow generating device 121 out of the upper lid 11 to exchange the air in the cooking cavity 20A. For the form of air blowing, the external airflow can be directed from the upper lid 11 to the cooking cavity 20A through the gas guiding component 123. For the form of air suction, the airflow in the cooking cavity 20A can be directed to the upper lid 11 through the gas guiding component 123, and is guided through the upper cover 11 to the ambient environment. The ventilation device is configured to be a specific airflow generating device, to enable the airflow generating device to generate the airflow in the operating state to disturb the gas in the cooking cavity, and therefore ventilation is achieved.

In some embodiments, the control panel 13 can control the airflow generating device 121 to operate. In an embodiment, the control panel 13 is electrically connected to the airflow generating device 121, and the airflow generating device 121 is controlled to operate or not operate through the control panel 13. It can be understood that as the airflow generating device 121 is in the hollow cavity and the cooking apparatus 1 is in operation, the user is difficult to determine whether the airflow generating device 121 is operating or is operating normally. That is, it is difficult for the user to determine whether the cooking apparatus 1 is ventilated or is normally ventilated. When the user opens the lid assembly 10 in the ventilation state, the effect of removing the stale smell is affected. In some embodiments, the control panel 13 may be further configured to display the operating state of the airflow generating device 121. The operating state of the airflow generating device 121 includes at least one of the following information: the ventilation device being in operation or not in operation, operating parameters, etc. The operating parameters include an operating duration, an operating speed, an operating power and the like. The control panel is electrically connected to the airflow generating device, to allow the user to control the operation of the airflow generating device by means of the control panel. In addition, the operating state of the airflow generating device is directly displayed by the control panel to facilitate the user knowing the ventilation state of the cooking apparatus, to choose the appropriate time to open the lid to improve the cooking effect of the cooking apparatus.

In some other embodiments, the airflow working state of the airflow generating device may be displayed in other manners. As illustrated in FIG. 1, the ventilation device 12 further includes an externalized assembly 122 in communication with the airflow generating device 121. The externalized assembly 122 is configured to display the airflow. In an embodiment, the externalized assembly 122 may be a mechanical movable component, the movement state of which is used to determine the operating state of the airflow generating device 121.

In some embodiments, as illustrated in FIG. 4, the externalized assembly 122 includes a movable component 1221 and a transparent lid 1222. The movable component 1221 is configured to move under pushing of the airflow generated by the airflow generating device 121. In some embodiments, the movable component 1221 is directly or indirectly connected to the upper lid 11. An air duct is formed in the externalized assembly 122 and is in communication with the air duct of the airflow generating device 121. The air duct of the externalized assembly 122 may be an air duct formed by the externalized assembly 122 and is completely independent of the upper lid 11, or may be partially formed by the upper lid 11. The movable component 1221 is disposed in the air duct of the externalized assembly 122, the airflow from the airflow generating device 121 can push the movable component 1221 to move in the air duct of the externalized assembly 122, and a specific movement form may be rotation, swing, floating and the like. In an embodiment, the movable component 1221 may be wind blades or a turbine rotatably connected to the upper lid 11, and the movable component 1221 can rotate relative to the upper lid 11 under the pushing of the airflow.

As illustrated in FIG. 4, the transparent lid 1222 is disposed above the movable component 1221 and configured to observe the movement of the movable component 1221. In some embodiments, the user observes the movement state of the movable component 1221 through the transparent lid 1222. For example, when the user observes through the transparent lid 1222 that the movable component 1221 moves, it is indicated that the airflow exists in the air duct of the externalized assembly 122. That is, the airflow generating device 121 is in the operating state, and the cooking apparatus 1 is in the ventilation state. When the user observes through the transparent lid 1222 that the movable component 1221 does not move, it is indicated that the airflow generating apparatus 121 is not in operation, and the cooking apparatus 1 is not ventilated. When the user observes through the transparent lid 1222 that the movable component 1221 rotates at a high speed, it is indicated that the cooking apparatus 1 is quickly ventilated. When the user observes through the transparent lid 1222 that the movable component 1221 rotates at a low speed, it is indicated that the cooking apparatus 1 is slowly ventilated. That is, the user can visualize the operating state of the cooking apparatus 1 by directly observing the movement state of the movable component 1221 through the transparent lid 1222.

The externalized assembly is configured to be a specific structure in the form of the movable component and the transparent lid, to enable the operating state of the airflow generating device to be indirectly displayed in a mechanical movement mode, and therefore the operating state of the cooking apparatus is determined. This configuration mode is simple in structure and high in reliability.

In some embodiments, the externalized assembly 122 is a part of the upper lid 11. That is, the externalized assembly 122 is partially composed of the upper lid 11. In an embodiment, as illustrated in FIG. 4, a first accommodation cavity 11B is formed in the upper lid 11, and the movable component 1221 is accommodated within the first accommodation cavity 11B. The transparent lid 1222 is fixedly connected to the upper lid 11 to close an opening of the first accommodation cavity 11B at an end of the first accommodation cavity. In some embodiments, the opening is closed by the transparent lid 1222. The first accommodation cavity 11B may be the air duct of the externalized assembly 122 and in communication with the air duct of the airflow generating device 121. The airflow from the air duct of the airflow generating device 121 is blown into the first accommodation cavity 11B, to push the movable component 1221 disposed in the first accommodation cavity 11B to move. That is, the through hole and the first accommodation cavity with an opening at an end thereof are formed by the structure of the upper lid. In this way, the number of the components of the lid assembly can be effectively reduced, and the structure can be simplified.

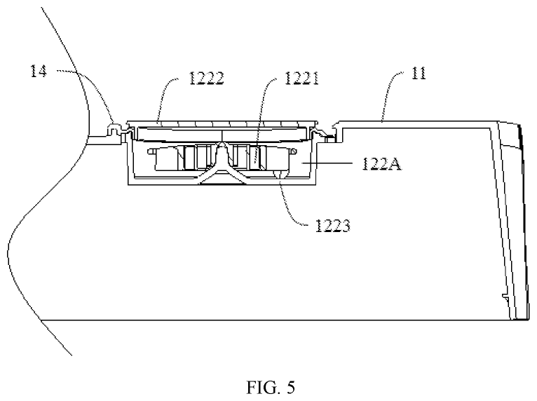

In some other embodiments, the externalized assembly 122 is independent of the structure of upper lid 11. In an embodiment, as illustrated in FIG. 5, the externalized assembly 122 includes a housing 1223, a second accommodation cavity 122 is formed by the housing 1223, and the movable component 1221 is accommodated within the second accommodation cavity 122A. In some embodiments, the second accommodation cavity 122A is formed with an opening at one end thereof, and the opening is enclosed by the housing 1223. The housing 1223 is fixedly connected to the upper lid 11, and the fixed connection manner may be bonding, clamping, fastener connection and the like. The housing 1223 is supported and positioned by the upper lid 11. The transparent lid 1222 is connected to the housing 1223 to close the opening at the end of the second accommodation cavity 122A. A complete structure of the externalized assembly can be formed by the housing, the movable component, and the transparent lid. In comparison with an integrally formed arrangement, this structure is more flexible in arrangement, and facilitates replacement of the components.

In some embodiments, as illustrated in FIG. 4 and FIG. 5, the lid assembly 10 further includes a sealing isolation component 14. In some embodiments, a sealing isolation function of the sealing isolation component 14 can effectively reduce the risk that the vapor discharged from the first mounting region S1 enters the first accommodation cavity 11B or the second accommodation cavity 122A, which improves the operating stability and reliability of the lid assembly 10.

The above description is merely some embodiments of the present disclosure, and is not intended to limit the scope of the present disclosure.

1. A lid assembly, comprising:
an upper lid a first mounting region and a second mounting region in a projection of the upper lid on a first plane, the first mounting region, and the second mounting region being spaced apart from each other by a first predetermined value, the first plane being perpendicular to a thickness direction of the upper lid and a through hole being formed in the first mounting region and configured to discharge steam; and
a ventilation device configured to generate an airflow and connected to the upper lid wherein the ventilation device is disposed in the second mounting region.

2. The lid assembly according to claim 1, wherein the first predetermined value is greater than or equal to 20 mm.

3. The lid assembly according to claim 1, wherein: the upper lid further has a third mounting region spaced apart from each of the first mounting region and the second mounting region.

4. The lid assembly according to claim 3, wherein the second mounting region and the third mounting region are spaced apart from each other by a second predetermined value greater than or equal to 20 mm.

5. The lid assembly according to claim 31, wherein: the ventilation device comprises an airflow generating device configured to generate the airflow in an operating state.

6. The lid assembly according to claim 5, wherein the ventilation device further comprises an externalized assembly communication with the airflow generating device, the externalized assembly being configured to display the airflow.

7. The lid assembly according to claim 3, wherein the second mounting region is located between the first mounting region and the third mounting region.

8. The lid assembly according to claim 6, wherein the externalized assembly comprises:
a movable component configured to move under pushing of the airflow generated by the airflow generating device; and
a transparent lid disposed above the movable component and configured to observe movement of the movable component.

9. The lid assembly according to claim 8, wherein:
the upper lid has a first accommodation cavity, the movable component being accommodated within the first accommodation cavity and the transparent lid being fixedly connected to the upper lid to close an opening at an end of the first accommodation cavity; or
the externalized assembly further comprises a housing, the housing having a second accommodation cavity, the movable component being accommodated within the second accommodation cavity, the transparent lid being connected to the housing to close an opening at an end of the second accommodation cavity, wherein the externalized assembly is fixedly connected to the upper lid.

10. A cooking apparatus, comprising:
the lid assembly according to claim 1; and
a body having a cooking cavity with an opening at an end of the body, wherein:
the lid assembly is configured to expose or close the opening of the cooking cavity; and
the ventilation device is configured to generate an airflow to disturb gas in the cooking cavity.

11. The lid assembly according to claim 3, wherein the lid assembly further comprises a control panel disposed in the third mounting region.

12. The lid assembly according to claim 11, wherein the control panel is configured to control the airflow generating device to operate.

13. The lid assembly according to claim 1, wherein the first predetermined value is greater than or equal to 20 mm.

14. The cooking apparatus according to claim 10, wherein: the upper lid further has a third mounting region spaced apart from each of the first mounting region and the second mounting region; and
the lid assembly further comprises a control panel disposed in the third mounting region.

15. The cooking apparatus according to claim 14, wherein the second mounting region and the third mounting region are spaced apart from each other by a second predetermined value greater than or equal to 20 mm.

16. The cooking apparatus according to claim 14, wherein: the ventilation device comprises an airflow generating device configured to generate the airflow in an operating state; and
the control panel is configured to control the airflow generating device to operate.

17. The cooking apparatus according to claim 16, wherein the ventilation device further comprises an externalized assembly in communication with the airflow generating device, the externalized assembly being configured to display the airflow.

18. The cooking apparatus according to claim 14, wherein the second mounting region is located between the first mounting region and the third mounting region.

19. The cooking apparatus according to claim 17, wherein the externalized assembly comprises:
a movable component configured to move under pushing of the airflow generated by the airflow generating device; and
a transparent lid disposed above the movable component and configured to observe movement of the movable component.

20. The cooking apparatus according to claim 19, wherein:
the upper lid has a first accommodation cavity, the movable component being accommodated within the first accommodation cavity, and the transparent lid being fixedly connected to the upper lid to close an opening at an end of the first accommodation cavity; or
the externalized assembly further comprises a housing, the housing having a second accommodation cavity, the movable component being accommodated within the second accommodation cavity, the transparent lid being connected to the housing to close an opening at an end of the second accommodation cavity, wherein the externalized assembly is fixedly connected to the upper lid.
